(19) United States
(12) Patent Application Publication
(10) Pub. No.: US 2026/0014987 A1
(43) Pub. Date: Jan. 15, 2026

(54) INFORMATION PROCESSING APPARATUS, INFORMATION PROCESSING METHOD, AND STORAGE MEDIUM

(71) Applicant: Toyota Jidosha Kabushiki Kaisha, Toyota-shi (JP)

(72) Inventor: Masaki TAKANO, Susono-shi (JP)

(73) Assignee: Toyota Jidosha Kabushiki Kaisha, Toyota-shi (JP)

(21) Appl. No.: 19/261,303

(22) Filed: Jul. 7, 2025

(30) Foreign Application Priority Data
Jul. 9, 2024 (JP) 2024-110462

(51) Int. Cl. B60W 30/16; B60W 60/00; G06V 20/58; H04W 4/46

(52) U.S. Cl. CPC B60W 30/16; B60W 60/001; G06V 20/582; H04W 4/46; B60W 2420/403; B60W 2554/4041; B60W 2554/4049; B60W 2554/80; B60W 2555/60; B60W 2556/65; G06V 2201/07

(57) ABSTRACT

An information processing apparatus comprises a controller configured to execute: recognizing a predetermined target object based on an image acquired by a camera of a first mobile body; estimating in advance a first probability that is a probability of not being able to normally recognize a first target object, which is a target of the recognition, by the first target object being hidden by a second mobile body; and modifying a travel plan for the first mobile body based on the first probability.

### CROSS REFERENCE TO THE RELATED APPLICATION

This application claims the benefit of Japanese Patent Application No. 2024-110462, filed on Jul. 9, 2024, which is hereby incorporated by reference herein in its entirety.

### BACKGROUND

### Technical Field

The present disclosure relates to vehicle technologies.

### Description of the Related Art

There is a technology of generating roadmap data in real time while sensing a road environment.

In relation thereto, for example, Japanese Patent Laid-Open No. 2021-100827 discloses an apparatus that generates a target trajectory of a vehicle based on the result of sensing.

### SUMMARY

An object of the present disclosure is to improve the accuracy of recognizing a road environment.

The present disclosure in its one aspect provides an information processing apparatus comprising: a controller configured to execute: recognizing a predetermined target object based on an image acquired by a camera of a first mobile body; estimating in advance a first probability that is a probability of not being able to normally recognize a first target object, which is a target of the recognition, by the first target object being hidden by a second mobile body; and modifying a travel plan for the first mobile body based on the first probability.

The present disclosure in its another aspect provides an information processing method to be executed by a computer, the information processing method comprising: a first step of recognizing a predetermined target object based on an image acquired by a camera of a first mobile body; a second step of estimating in advance a first probability that is a probability of not being able to normally recognize a first target object, which is a target of the recognition, by the first target object being hidden by a second mobile body; and a third step of modifying a travel plan for the first mobile body based on the first probability.

Furthermore, as another aspect, a program for causing a computer to execute the information processing method described above or a computer-readable storage medium that non-transitorily stores the program is given.

According to the present disclosure, it is possible to improve the accuracy of recognizing a road environment.

### BRIEF DESCRIPTION OF THE DRAWINGS

FIGS. 1A and 1B are diagrams for explaining a problem in the present disclosure;

FIG. 2 is a diagram illustrating the hardware configuration of an onboard apparatus 10;

FIG. 3 is a diagram illustrating the software configuration of the onboard apparatus 10;

FIG. 4 is an example of guide data stored in the onboard apparatus 10;

FIG. 5 is a diagram illustrating road network topology;

FIG. 6 is a diagram illustrating a flow of data in a first process;

FIG. 7 is a diagram illustrating a flow of data in a second process;

FIG. 8 is a flowchart of a process executed in the first process;

FIG. 9 is a flowchart of a process executed in the second process; and

FIG. 10 is a flowchart illustrating the process of step S24 in detail.

### DESCRIPTION OF THE EMBODIMENTS

Recently, research into an autonomous travel system in which a vehicle autonomously travels along a route set in advance has been progressed. The vehicle that autonomously travels judges its position and posture by comparing a roadmap stored in advance and a result of sensing a road environment.

In such a system, however, a problem occurs that it is necessary to always keep the roadmap up-to-date. For example, when a building or a structure that exists along a road has been demolished, an inconsistency with the roadmap occurs. Therefore, there is a possibility that it becomes impossible for the vehicle to correctly recognize its own position. When a part of lanes is closed due to construction or the like, a similar problem also occurs. Though there is a method of updating the roadmap based on information collected by probe cars, it is not possible to solve the above problem because of occurrence of a time lag.

In order to cope therewith, a technology of traveling while recognizing a road environment in real time, without a roadmap being held on the vehicle side has been researched. For example, a vehicle holds only data for road directions (guide data) and decides its own travel trajectory based on a result of recognizing a road area (a travelable area) in real time.

The data for road directions (the guide data) is, for example, data in which approximate locations of intersections, forks, and the like, and travel directions are recorded. By comparing the data and a sensing result, the vehicle judges, for example, a point to turn right/left on a route.

For example, when the vehicle traveling on an expressway needs to exit at an interchange with a certain name, the vehicle can recognize that the interchange to exit at is approaching by reading the name of the interchange written on a guide sign existing short of the interchange.

When the vehicle travels, sensing a road environment, however, a case may occur where, depending on a positional relationship with another vehicle, a target object to recognize is hidden and cannot be recognized. For example, when a large vehicle is traveling just in front of the vehicle, it may happen that the vehicle cannot capture a guide sign (for example, a guide for the interchange) that is hung above the vehicle by a camera and passes through the target interchange.

An information processing apparatus according to the present disclosure solves such a problem.

An information processing apparatus according to one aspect of the present disclosure includes a controller that executes: recognizing a predetermined target object based on an image acquired by a camera of a first mobile body; estimating in advance a first probability that is a probability of not being able to normally recognize a first target object, which is a target of the recognition, by the first target object being hidden by a second mobile body; and modifying a travel plan for the first mobile body based on the first probability.

The first and second mobile bodies are typically vehicles.

The information processing apparatus according to the present disclosure may be an onboard apparatus mounted on the first mobile body or may be a server apparatus that performs a process based on an image acquired by the first mobile body and issues an instruction to the first mobile body.

The controller executes a first process for recognizing a predetermined target object based on an image acquired by the camera (for example, an onboard camera). The predetermined target object is an arbitrary object used for deciding a travel course of a vehicle. For example, the controller can recognize an intersection to turn right/left at, based on a recognized guide sign.

Furthermore, the controller estimates the probability of not being able to normally recognize the first target object by the first target object being hidden by the second mobile body. The second mobile body is another mobile body (a vehicle or the like) that can be near the first mobile body.

The first probability may be calculated based on a percentage of a hidden part of the first target object to the whole. This is because it is more conceivable to fail in recognition of the first object as the percentage of the hidden part of the first target object to the whole is higher.

Furthermore, the first probability may be calculated based on the probability of the second mobile body hiding the first target object. This is because it is more conceivable to fail in recognition of the first object as the probability of the first target object being hidden is higher.

The first probability can be calculated, for example, based on a result of estimating a relative positional relationship between the first mobile body and the second mobile body at the timing when the first mobile body passes near the first target object. Therefore, the controller may estimate the relative positional relationship and calculate the first probability based on a result of the estimation.

The controller modifies the travel plan for the first mobile body to change the positional relationship with the second mobile body, based on the first probability. For example, when the estimated first probability is equal to or above a predetermined value, the controller modifies the travel plan for the first mobile body so that the estimated relative positional relationship is changed. For example, the controller may modify the travel plan so that the first mobile body is away from the second mobile body by a predetermined distance or more in a section in which the first target object is within the view of the camera. Thereby, it is possible to secure the view for recognizing the first target object.

Furthermore, the first mobile body may be an autonomous vehicle that travels along a predetermined route, and the controller may acquire in advance information about one or more first target objects that need to be recognized on the predetermined route.

The first target objects may be, for example, objects for announcing locations of road forks. As such target objects, for example, signs and sign boards for announcing intersections and interchanges can be exemplified. The controller may acquire information about such first target objects (for example, their appearance feature, name, approximate location information, and the like) in advance. Thereby, it becomes possible for the controller to judge a section in which the first target objects are presumed to be seen.

Furthermore, the controller may acquire travel data about travel of one or more second mobile bodies traveling near the first mobile body.

The travel data is data for estimating movements of the second mobile bodies. The travel data may be generated based on a result of observing the second mobile bodies from the outside. Furthermore, when it is possible to communicate with an apparatus that controls travel of the second movement objects, data of travel plans for the second mobile bodies may be acquired from the apparatus as the travel data.

For example, when the second mobile bodies are autonomous vehicles or semi-autonomous vehicles, the controller may acquire the travel data included in V2X messages transmitted from the apparatus that controls travel of the second mobile bodies.

Note that the controller may generate the travel data based on results of sensing the second mobile bodies. For example, by analyzing the speeds and movements of the second mobile bodies captured by the camera, it is possible to estimate relative positional relationships between the first mobile body and the second mobile bodies.

An embodiment of the present disclosure will be described below based on drawings. The configuration of the embodiment below is an exemplification, and the present disclosure is not limited to the configuration of the embodiment.

### First Embodiment

An overview of a vehicle system according to a first embodiment will be described. The vehicle system according to the present embodiment is configured, including a vehicle 1 and an onboard apparatus 10 mounted on the vehicle 1. The onboard apparatus 10 is connected to an onboard camera 11.

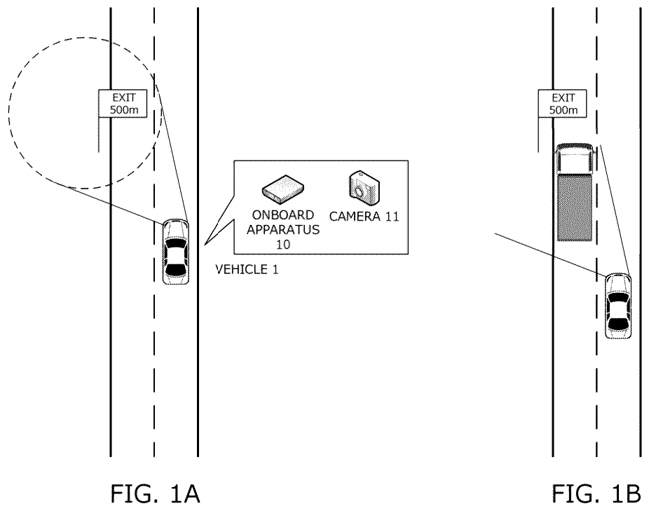

A description will be made on a problem to be solved by the system with reference to FIGS. 1A and 1B.

The onboard apparatus 10 mounted on the vehicle 1 recognizes a road area around the vehicle 1 based on an image captured by the onboard camera 11 and executes control to cause the vehicle 1 to autonomously travel, using a recognition result.

The road area is typically an area where the vehicle 1 can travel. The road area can be recognized by detecting road boundaries (road edges), but a recognition target is not limited to road edges. For example, lane markings, a lane centerline, a road centerline, or the like may be a recognition target.

The onboard apparatus 10 stores data for road directions to a destination (guide data), and causes the vehicle 1 to travel according to the guide data along the recognized road area.

The guide data is typically data defining waypoints such as intersections, forks, and interchanges on a route (nodes in a road network). The guide data includes data announcing a direction for the vehicle 1 to travel in at each waypoint, characteristics of the waypoint, a method for recognizing the waypoint, and the like.

FIG. 1A is a plan view illustrating the vehicle 1 traveling on an expressway. Here, it is assumed that an interchange at which the vehicle 1 should exit is defined as a waypoint in the guide data, and the vehicle 1 exits from the specified interchange according to the guide data.

Existence of the interchange can be recognized, for example, using a guide sign installed short of the interchange. For example, when recognizing a sign announcing that “the target interchange is 500 m ahead” by the onboard camera 11, the onboard apparatus 10 starts lane change and the like for exit.

However, there may be a case where, depending on a positional relationship with another vehicle, it becomes impossible for the onboard camera to capture such a target. For example, when a large vehicle exists between the vehicle 1 and a target object (a guide sign) like FIG. 1B, the view of the onboard camera 11 may be obstructed, and it may be impossible to visually capture the target object. In such a case, a problem can occur that the existence of the interchange cannot be detected, and it is not possible to correctly exit.

Therefore, the onboard apparatus 10 according to the present embodiment acquires information about movement of another vehicle traveling near the vehicle 1 (hereinafter referred to as “the other vehicle”) and adjusts a positional relationship with the other vehicle so that hiding by the other vehicle does not occur when the vehicle 1 passes near a predetermined target object.

For example, by taking measures such as “traveling at a distance from a large vehicle that is likely to cause hiding” and “moving to a position where hiding does not occur” in advance, it becomes possible to certainly capture target objects that need to be recognized for autonomous travel.

### [Hardware Configuration]

Next, the hardware configuration of each apparatus constituting the system will be described.

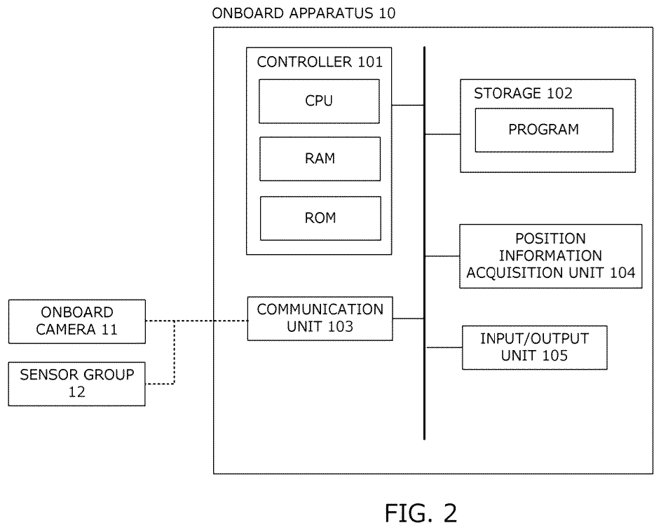

First, the components of the vehicle 1 will be described. FIG. 2 is a diagram schematically illustrating an example of the hardware configuration of the onboard apparatus 10 mounted on the vehicle 1. The vehicle 1 is configured, including the onboard apparatus 10, the onboard camera 11, and a sensor group 12.

The onboard apparatus 10 can be configured as a computer that includes a processor (a CPU, a GPU, or the like), a main memory (a RAM, a ROM, and the like), and an auxiliary storage device (an EPROM, a hard disk drive, a removable medium, or the like). In the auxiliary storage device, an operating system (OS), various kinds of programs, various kinds of tables, and the like are stored, and each of functions (software modules) fitting for predetermined purposes as described later can be realized by executing a program stored in the auxiliary storage device. A part or all of the functions, however, may be realized as hardware modules, for example, by a hardware circuit such as an ASIC or an FPGA.

The onboard apparatus 10 is configured, including a controller 101, a storage 102, a communication unit 103, a position information acquisition unit 104, and an input/output unit 105.

The controller 101 is an arithmetic unit that realizes the various functions of the onboard apparatus 10 by executing a predetermined program. The controller 101 can be realized, for example, by a hardware processor such as a CPU. Furthermore, the controller 101 may be configured, including a random access memory (RAM), a read-only memory (ROM), a cache memory, and the like.

The storage 102 is means for storing information, and is configured with a storage medium such as a RAM, a magnetic disk, or a flash memory. In the storage 102, the program to be executed by the controller 101, and data and the like to be used by the program are stored.

The communication unit 103 is a communication interface for connecting the onboard apparatus 10 to a vehicle network. The communication unit 103 is configured to be communicable with the onboard components of the vehicle 1 via a network, for example, a controller area network (CAN).

The position information acquisition unit 104 acquires position information about the vehicle 1. The position information acquisition unit 104 includes a GPS antenna and a positioning module for obtaining the position information. The GPS antenna is an antenna that receives a positioning signal transmitted from a positioning satellite (also referred to as a GNSS satellite). The positioning module is a module that calculates the position information based on a signal received by the GPS antenna. Note that the position information acquisition unit 104 may judge the travel direction of the vehicle 1 based on transition of the position information.

The onboard camera 11 is an optical unit that includes an image sensor for acquiring an image. The onboard camera 11 is mounted, for example, facing ahead of the vehicle 1.

The sensor group 12 is a set of a plurality of sensors of the vehicle 1. The plurality of sensors may be, for example, those that acquire data about travel of the vehicle 1, such as a speed sensor, an acceleration sensor, and a GPS module. Furthermore, the plurality of sensors may be those that acquire data about a travel environment of the vehicle 1.

The input/output unit 105 is a unit that accepts an input from a driver of the vehicle 1 and presents information to the driver. Specifically, the input/output unit 105 is configured with a touch panel and control means therefor, and a liquid crystal display and control means therefor. In the present embodiment, the touch panel and the liquid crystal display are configured with one touch panel display.

### [Software Configuration]

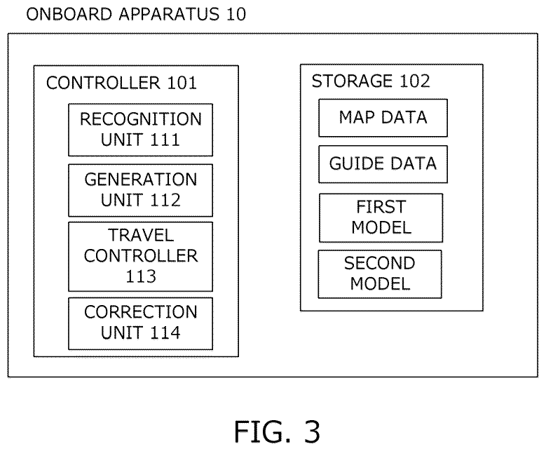

Next, the software configuration of each apparatus constituting the system will be described. FIG. 3 is a diagram schematically illustrating the software configuration of the onboard apparatus 10 according to the present embodiment.

In the present embodiment, the controller 101 of the onboard apparatus 10 is configured, including four software modules of a recognition unit 111, a generation unit 112, a travel controller 113, and a correction unit 114. Each of the software modules may be realized by executing a program stored in the storage 102 to be described later, by the controller 101 (such as a CPU). Information processing executed by the software modules is synonymous with information processing executed by the controller 101 (such as a CPU).

The software modules can be approximately classified into those having a role of recognizing a road environment and deciding a planned trajectory of the vehicle 1 and those having a role of estimating existence of a factor that obstructs recognition (that is, another vehicle that is likely to cause hiding) and modifying the planned trajectory of the vehicle 1.

First, the former will be described. The recognition unit 111, the generation unit 112, and the travel controller 113 recognize a road environment in the view by the onboard camera 11 and decides an appropriately trajectory of the vehicle 1 (a planned trajectory).

The recognition unit 111 acquires data from the onboard camera 11 and the sensor group 12 and recognizes the road environment in the view of the onboard camera 11. Specifically, the recognition unit 111 inputs image data acquired from the onboard camera 11 and sensor data acquired from the sensor group 12 to machine learning models stored in the storage 102. The image data is data obtained by capturing scenery in front of the vehicle 1, and the sensor data includes position information and posture information about the vehicle 1.

In the present embodiment, the recognition unit 111 uses a model for recognizing objects on a road (a first model) and a model for recognizing road network topology (a second model) as machine learning models.

The first model is a model that estimates locations of objects in space, based on the image data and the sensor data. An object may be anything that is referred to at the time of performing autonomous travel, for example, a road boundary, lane markings, traffic lights, a pedestrian crossing, or a stop line. The first model outputs information about locations of recognized objects in space (hereinafter referred to as geographical feature information).

The second model is a model that estimates road network topology based on the image data and the sensor data. The road network topology is, for example, information showing an aspect of connections among a plurality of lanes. The road network topology may be, for example, such that connection relationships among lanes are expressed by nodes and edges. Thereby, for example, it becomes possible to make a judgment that “it is possible to, on a road where two lanes are parallel, turn right at the next intersection (transition to the edge of an intersecting road) by traveling on the right-side lane”. The second model outputs connection relationships among one or more road edges included in the view of the onboard camera as information about road network topology (hereinafter referred to as the topology information).

By using the second model, it becomes possible for the onboard apparatus 10 to recognize connection relationships among a plurality of road edges.

The generation unit 112 generates map data based on a result of recognition performed by the recognition unit 111. The map data is two-dimensional or three-dimensional roadmap data showing a travelable area (a road area) in the view captured by the onboard camera 11. The generation unit 112 maps objects shown by the geographical feature information in space. Thereby, a roadmap on which a travelable road area, lanes, and the like are mapped is obtained. On the roadmap, the current position and orientation of the vehicle 1 may be mapped.

Moreover, the generation unit 112 adds information about network topology among the lanes, on the obtained map. By using such a roadmap, it becomes possible to, for example, when two-lane roads cross at grade, make a judgment that “it is possible to merge with the left lane of a crossing road by traveling on the left-side lane”, and it becomes possible to appropriately decide a planned trajectory in autonomous travel.

The travel controller 113 decides a trajectory of the vehicle 1 based on the map data generated by the generation unit 112 and guide data created in advance and causes the vehicle 1 to travel.

As for a method for causing the vehicle 1 to autonomously travel, a publicly known method can be adopted. In the present embodiment, the travel controller 113 decides the trajectory of the vehicle 1 according to the generated map data, and detects waypoints shown by the guide data and sets a travel course of the vehicle 1 in an appropriate direction at each of the waypoints.

In the description below, information indicating the planned trajectory of the vehicle 1 decided by the travel controller 113 will be referred to as a “travel plan”.

The travel controller 113 causes the vehicle 1 to travel while appropriately deciding a travel plan in the view.

As stated before, there is a possibility that, when the view of the onboard camera 11 is obstructed by another vehicle, it becomes impossible to correctly recognize a waypoint. Thereby, there is also a possibility that it becomes impossible for the vehicle 1 to travel to an appropriate road edge at a fork point, an intersection, or the like. In order to cope therewith, the correction unit 114 estimates existence of another vehicle that is likely to cause hiding, and modifies the travel plan decided by the travel controller 113 based on a result thereof.

In the present embodiment, the correction unit 114 detects another vehicle existing near the vehicle 1 based on video acquired by the onboard camera 11, and estimates change in a relative positional relationship between the vehicle 1 and the other vehicle. Then, the correction unit 114 calculates a probability of, when the vehicle 1 passes near an object for identifying a waypoint (for example, a guide sign), not being able to normally recognize the object because of the object being hidden by the other vehicle (“a first probability” in the present disclosure). As the value calculated here is larger, it is presumed to be more impossible to correctly recognize the object. Therefore, when the probability exceeds a predetermined value, the correction unit 114 interacts with the travel controller 113 to modify the travel plan.

For example, the correction unit 114 may cause the travel plan to be modified so that the vehicle 1 may keep a certain distance from the other vehicle at the timing of passing near the target object. Thereby, it becomes possible to cause objects that need to be recognized to be certainly recognized.

In the description below, objects that need to be visually recognized to identify waypoints will be referred to as “first target objects”. The first target objects may be structures existing at the waypoints or may be signs for announcing existence of the waypoints in advance.

In the present embodiment, the vehicle 1 acquires almost all information other than route information, including connection relationships among road edges, by the onboard camera and the sensors. Therefore, in order to detect waypoints, there are many objects to be recognized, such as signs, white lines, and road markings. The correction unit 114 may treat each of the plurality of objects as a first target object.

The storage 102 is means for storing information, and is configured with a storage medium such as a RAM, a magnetic disk, or a flash memory. In the storage 102, the program to be executed by the controller 101, and data and the like to be used by the program are stored.

In the storage 102, the map data, the guide data, the machine learning models (the first model and the second model), and the like that have been stated before are stored.

The map data of a range corresponding to the view of the onboard camera 11 is generated by the generation unit 112 as needed. Note that the generated map data may be deleted after passing or may be stored to be used for the next and subsequent travels. Furthermore, the map data may be transmitted outside in order to help autonomous travel of other vehicles.

The guide data is data for providing road directions in autonomous travel. The guide data may be data in which approximate locations of intersections, forks, and the like, and travel directions are recorded. The guide data is acquired from a predetermined apparatus (for example, an apparatus that performs route search) prior to start of travel.

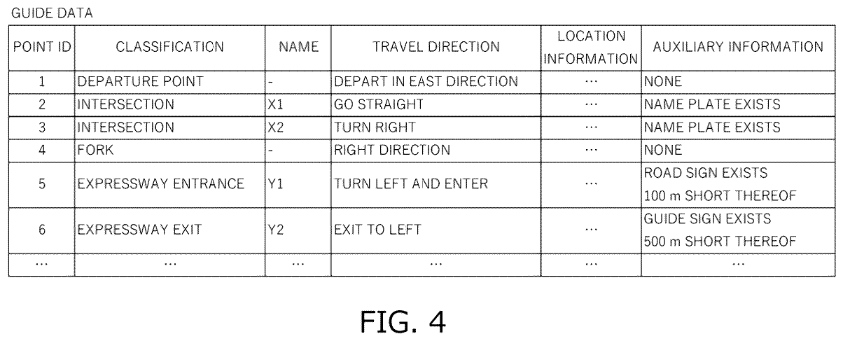

FIG. 4 is an example of the guide data. In the illustrated example, the guide data includes classifications of waypoints (intersection, fork, interchange, and the like), names of the waypoints, travel directions (right turn, left turn, and the like) at the waypoints, pieces of location information about the waypoints, and the like.

The vehicle 1 needs to visually recognize structures or buildings at waypoints (forks, interchanges, or the like) or visually recognize auxiliary objects announcing the waypoints in advance (guide signs or the like).

For example, in order to uniquely identify an intersection, it is necessary to read a name plate installed at the intersection. The guide data may include information about such auxiliary objects for identifying waypoints. The “auxiliary information” fields show examples of such information. For example, when the vehicle 1 needs to exit at an interchange with a certain name, the onboard apparatus 10 can recognize that the target interchange exists ahead, by reading a guide sign installed short of the interchange. In the auxiliary information fields, information about installation locations of such objects may be stored.

The first model is a machine learning model that estimates and outputs locations of objects on a road, with image data acquired by the onboard camera 11 and sensor data acquired by the sensor group 12 as an input. In the present embodiment, the first model recognizes road boundaries, lane markings, traffic lights, pedestrian crossings, stop lines, and the like as objects. The first model outputs a recognition result as “geographical feature information”.

The second model is a machine learning model that estimates and outputs road network topology, with image data acquired by the onboard camera 11 and sensor data acquired by the sensor group 12 as an input. The road network topology is, for example, information showing an aspect of connections among a plurality of lanes with nodes and edges.

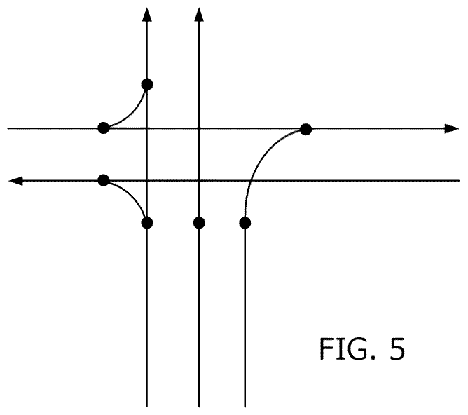

The second model outputs, for example, information that “there are three edges (lanes) in the view, the rightmost edge is connected to an edge of a crossing road by right turn, and the leftmost edge is connected to the edge of the crossing road by left turn” as “topology information”. FIG. 5 is an example of the topology information that is visualized. Location information about the nodes and the edges is associated with the topology information.

Note that, as for a specific configuration of the onboard apparatus 10, it is possible to appropriately omit, replace, and add components according to an embodiment. For example, the controller 101 may include a plurality of hardware processors. Each of the hardware processors may be configured with a microprocessor, an FPGA, a GPU, or the like. Furthermore, an input/output device other than that exemplified above (for example, an optical drive or the like) may be added. Furthermore, the onboard apparatus 10 may be configured with a plurality of computers. In this case, the hardware configurations of the computers may be the same or may be different.

### [Details of Process]

Next, details of a process executed by the onboard apparatus 10 (the controller 101) will be described.

The process executed by the onboard apparatus 10 (the controller 101) is approximately separated into a process for deciding an appropriate trajectory of the vehicle 1 based on a result of recognizing a road environment to control autonomous travel (a first process) and a process for estimating existence of a factor (another vehicle) that obstructs recognition to modify the trajectory (a second process).

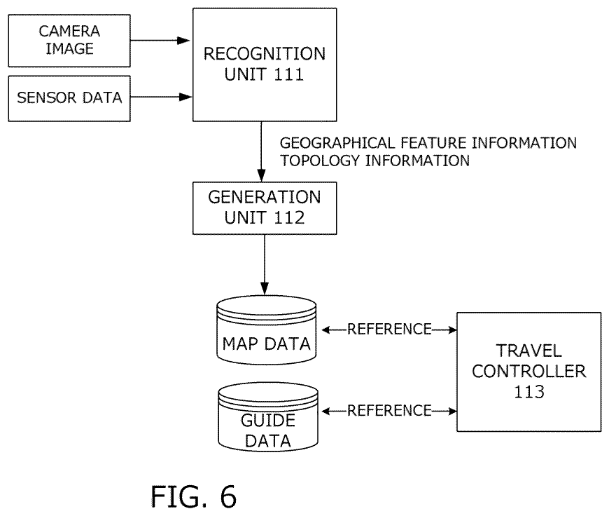

First, the first process will be described. FIG. 6 is an overview diagram illustrating a flow of data transmitted/received by the plurality of software modules of the controller 101.

First, a camera image acquired by the onboard camera 11 and sensor data acquired by the sensor group 12 are inputted to the recognition unit 111. In the present embodiment, the sensor data includes position information about the vehicle 1 and information about the posture of the vehicle 1 (for example, an orientation which is a travel direction). The recognition unit 111 inputs the data to each of the first and second models, and acquires geographical feature information and topology information as results of estimation.

The geographical feature information is information showing arrangement of objects (for example, road boundaries, lane markings, traffic lights, pedestrian crossings, and stop lines) in space. The topology information is information showing such road network topology as illustrated in FIG. 5.

The geographical feature information and the topology information outputted by the recognition unit 111 are transmitted to the generation unit 112. The generation unit 112 generates a roadmap by arranging the objects shown by the geographical feature information in space. Since the geographical feature information includes location information about road boundaries, it is possible to obtain a roadmap indicating a travelable road area by arranging the road boundaries. Furthermore, since the geographical feature information includes location information about lane markings, it is possible to obtain a roadmap having lane information by arranging the lane markings. Furthermore, the generation unit 112 arranges traffic-related objects, such as traffic lights, stop lines, pedestrian crossings, and guide signs, on the roadmap. Note that names and the like may be associated with the objects. For example, when a recognition target object is a guide sign or when the recognition target object is traffic lights, and an intersection name plate is attached to the traffic lights, the generation unit 112 may associate a read name with the object.

Moreover, the generation unit 112 adds the topology information to the generated roadmap. The topology information is information showing an aspect of connections among a plurality of lanes as described with reference to FIG. 5. Since location information is associated with the topology information, the generation unit 112 gives network topology information to each lane included in the roadmap based on the topology information. Thereby, information such as “whether it is possible to transition from a certain lane (edge) to another lane (edge)” is given to the roadmap.

The generation unit 112 stores the roadmap obtained by the above process as map data.

The travel controller 113 generates a travel trajectory of the vehicle 1 by referring to the map data generated by the generation unit 112. Furthermore, the travel controller 113 refers to guide data, and detects waypoints defined in the guide data and sets an appropriate travel course. For example, when the guide data includes information of an instruction to “turn left at an intersection with the name of X”, and the generated map data includes the intersection with the name of X, the travel controller 113 generates a trajectory that turns left at the intersection.

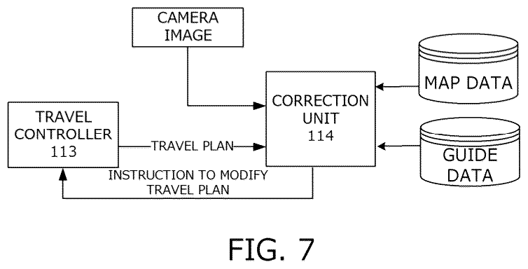

Next, the second process will be described. The second process is executed by the correction unit 114. FIG. 7 is an overview diagram illustrating a flow of data transmitted/received by the correction unit 114. The correction unit 114 performs the following four types of processes.

### (1) Process for Judging the Timing of Passing Near a First Target Object

As described with reference to FIG. 4, the onboard apparatus 10 needs to visually recognize structures or buildings (forks, interchanges, or the like) existing at waypoints or auxiliary objects (guide signs or the like) for announcing the waypoints in advance. Therefore, the correction unit 114 estimates the timing when the vehicle 1 passes near a target object (a first target object). The estimation can be performed based on the map data or the guide data. For example, the correction unit 114 judges that the vehicle 1 passes near a first target object within one minute based on location information about waypoints defined in the guide data and position information about the vehicle 1.

(2) Process for Acquiring Data about Movement of Another Vehicle Positioned Near the Vehicle 1

The correction unit 114 acquires data about movement of another vehicle traveling near the vehicle 1 based on image data acquired from the onboard camera 11. The data about movement of another vehicle may be, for example, data showing change in the relative position of the other vehicle relative to the vehicle 1 over time (hereinafter referred to as relative position data). The correction unit 114 may judge the change in the relative position over time based on change in the position of the other vehicle over time in the image.

Furthermore, the correction unit 114 may judge the change in the relative position relative to the other vehicle over time, using sensor data acquired from the sensor group 12 together. Moreover, the correction unit 114 may acquire a travel plan (a planned trajectory) from the travel controller 113 and judge the change in the relative position relative to the other vehicle over time based thereon.

### (3) Process for Calculating a First Probability Based on Relative Position Data

The correction unit 114 calculates the probability of the first target object being hidden by the other vehicle or the extent of hiding based on the acquired relative position data, and calculates the probability of not being able to correctly recognize the first target object (a first probability) based thereon.

The first probability may be calculated, for example, based on an estimated distance between the vehicle 1 and the other vehicle at the timing when the vehicle 1 passes near the first target object. For example, such a setting may be made that the first probability is higher when the distance between the vehicle 1 and the other vehicle is shorter. Furthermore, the first probability may be calculated, for example, based on a positional relationship among the vehicle 1, the other vehicle, and the first target object (how they are positioned) at the timing when the vehicle 1 passes near the first target object.

Furthermore, the first probability may be calculated based on a result of simulating the view of the onboard camera 11 in three-dimensional space.

### (4) Process for Modifying a Travel Plan Based on the Calculated First Probability

When the calculated first probability exceeds a threshold, the correction unit 114 interacts with the travel controller 113 to modify a travel plan so that hiding by the other vehicle may not occur. For example, the correction unit 114 instructs the travel controller 113 to modify the travel plan so that the distance between the vehicle 1 and the other vehicle may become equal to or above a predetermined value (or the positional relationship therebetween becomes such that the first target object can be visually confirmed) before passing near the first target object.

Thereby, for example, it is possible to perform control to “temporarily decelerate to increase the distance from the other vehicle” or “change the lane to move to a position where the first target object is not hidden by the other vehicle”.

### [Process Flows]

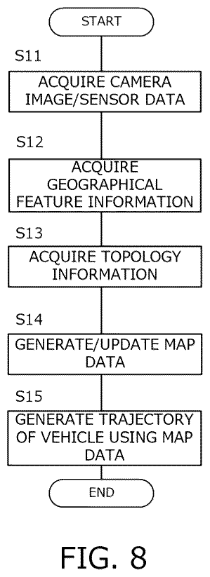

Next, flows of the processes executed by the onboard apparatus 10 will be described. FIG. 8 is a flowchart of the process for deciding an appropriate trajectory of the vehicle 1 based on a result of recognizing a road environment to control autonomous travel (the first process). The illustrated process is periodically executed while the vehicle 1 is traveling.

First, in step S11, the recognition unit 111 acquires a camera image from the onboard camera 11 and acquires sensor data from the sensor group 12.

Next, in step S12, the recognition unit 111 acquires geographical feature information based on the camera image and the sensor data. In this step, the recognition unit 111 inputs the image data and the sensor data to the first model and acquires outputted geographical feature information. The geographical feature information includes location information about road boundaries, lane markings, traffic lights, pedestrian crossings, stop lines, and the like in space.

In step S13, the recognition unit 111 acquires topology information based on the camera image and the sensor data. In this step, the recognition unit 111 inputs the image data and the sensor data to the second model and acquires outputted topology information. The topology information is information indicating road network topology for each lane.

Next, in step S14, the generation unit 112 generates map data based on the geographical feature information and the topology information. In this step, the generation unit 112 generates a roadmap by arranging the objects shown by the geographical feature information in space, and adds the topology information to the generated roadmap. The roadmap obtained by this process is temporarily stored as map data.

Next, in step S15, the travel controller 113 generates a planned trajectory of the vehicle 1 in the view captured by the onboard camera 11, based on the generated map data. Furthermore, the travel controller 113 refers to guide data, and detects waypoints defined in the guide data and sets an appropriate travel course.

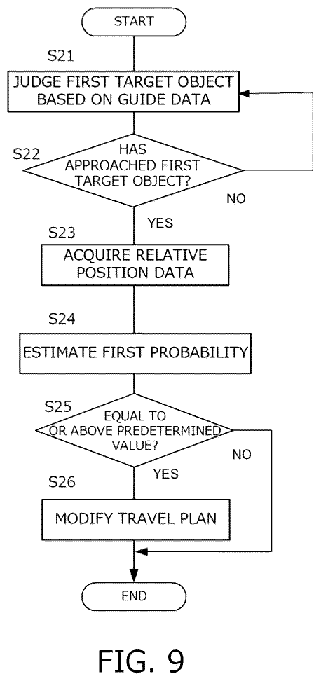

Next, a flow of the process for the onboard apparatus 10 to estimate existence of another vehicle that can obstruct recognition of an object to modify the trajectory (the second process) will be described. FIG. 9 is a flowchart of the second process. The illustrated process is periodically executed while the vehicle 1 is traveling.

First, in step S21, the correction unit 114 judges existence of first target objects that needs to be recognized, on the route. In this step, the correction unit 114 judges a first target object that needs to be recognized next, based on the guide data and position information about the vehicle 1.

Next, in step S22, the correction unit 114 judges whether the vehicle 1 has approached the first target object or not. This judgment can be made based on the map data and the guide data. For example, the correction unit 114 judges that the vehicle 1 has come to a point within 500 m to the first target object, based on location information about waypoints defined in the guide data and position information about the vehicle 1. If a positive judgment is made in this step, the process transitions to step S23. If a negative judgment is made in this step, the process returns to step S21.

Next, in step S23, the correction unit 114 acquires data showing change in a relative position of another vehicle traveling near the vehicle 1 and the vehicle 1 over time (relative position data). The relative position data may be generated by the correction unit 114 based on change in the position of the other vehicle over time in the image and the planned trajectory generated by the travel controller 113.

Next, in step S24, the correction unit 114 estimates the first probability.

As stated before, the first probability can be calculated based on a relative positional relationship between the vehicle 1 and the other vehicle, and the like at the timing when the vehicle 1 passes near the first target object.

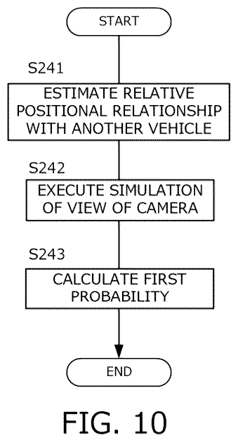

FIG. 10 is a flowchart illustrating an example of the process executed in step S24 in more detail.

First, in step S241, the correction unit 114 estimates the relative positional relationship between the vehicle 1 and the other vehicle at the timing when the vehicle 1 passes near the first target object. The relative positional relationship between the vehicle 1 and the other vehicle can be decided, for example, based on the relative position data acquired in step S23, the travel plan (the planned trajectory or the like) acquired from the travel controller 113. The relative positional relationship may include distance information.

Next, in step S242, the correction unit 114 executes simulation of the view of the onboard camera 11. In this step, the simulation of the view may be performed based on the position where the onboard camera 11 is mounted, and the size of the other vehicle. In this case, the correction unit 114 may perform simulation a plurality of times while changing parameters, and measure what percentage of hiding has occurred.

Then, the correction unit 114 calculates the first probability based on a result of the simulation (step S243).

Note that, though the correction unit 114 performs simulation of the view in the present example, the first probability may be determined by another method. For example, a table in which positional relationships and distances among a first target object, the vehicle 1, and another vehicle are defined in association with first probabilities may be prepared to determine the first probability by the table. Furthermore, the first probability may be determined using a machine learning model. For example, a machine learning model can be used which has learned relationships between positional relationships and distances among a first target object, the vehicle 1, and another vehicle, and first probabilities.

In step S25, the correction unit 114 judges whether or not the estimated first probability is equal to or above a predetermined value. If the estimated first probability is equal to or above the predetermined value, the process transitions to step S26. If the estimated first probability is below the predetermined value, the process ends.

In step S26, the correction unit 114 instructs the travel controller 113 to modify the travel plan. The instruction may include information for identifying the other vehicle that causes hiding. For example, in response to the instruction, the travel controller 113 causes the vehicle 1 to move to a position where the view of the onboard camera 11 is not obstructed by the other vehicle.

As described above, the onboard apparatus 10 according to the first embodiment presumes that there is a possibility that a first target object that needs to be recognized by the onboard camera 11 during travel is hidden by another vehicle and modifies a travel plan for the vehicle 1 in advance. Thereby, it is possible to improve reliability of autonomous travel.

### Modification of First Embodiment

In the first embodiment, the relative positional relationship between the vehicle 1 and the other vehicle is estimated, using the image acquired by the onboard camera 11 in step S23. On the other hand, there may be a case where, when the other vehicle is performing autonomous travel or semi-autonomous travel, a planned trajectory and the like of the other vehicle can be acquired as data.

For example, a form is conceivable in which the other vehicle performs broadcast-transmission of its speed, travel direction, planned trajectory, and the like by a V2X message. In this case, by receiving the V2X message, the correction unit 114 can generate relative position data. Furthermore, there may be a case where autonomous travel is controlled by an external server apparatus. In this case, the correction unit 114 may acquire data about travel of the other vehicle from the server apparatus to generate the relative position data based thereon.

### Modification

The embodiment described above is a mere example, and the present disclosure can be appropriately changed and practiced within a range not departing from the gist thereof.

For example, the processes and means described in the present disclosure can be freely combined and implemented as far as technical inconsistencies do not occur.

Furthermore, though an example of the onboard apparatus 10 controlling autonomous travel of the vehicle 1 is given in the description of the embodiment, control of autonomous travel may be performed by a server apparatus installed at a place different from the vehicle 1. Furthermore, it is also possible for the vehicle 1 to execute the first process and for a server apparatus to execute the second process.

Furthermore, though the words “the vehicle 1” and “another/the other vehicle” are used in the description of the embodiment, the mobile bodies according to the present disclosure (the first and second mobile bodies) are not limited to vehicles. The mobile bodies according to the present disclosure may be, for example, robots, drones, or other mobile bodies that are autonomously movable.

Furthermore, in the description of the embodiment, the vehicle 1 has only route information (the guide data), and almost all the information for traveling along the route is acquired by the onboard camera and the sensors. The dependency on the onboard camera and the sensors, however, may be lower than the exemplified dependency. For example, when an onboard apparatus stores a roadmap in which connection relationships among road edges are defined, it may be possible to perform travel along a route if only the current lane can be recognized. In such a case, it is only necessary to perform control so that the objects for recognizing the lane are not hidden.

Furthermore, though control is performed so that all the first target objects included in the guide data may be prevented from being hidden, it is not necessarily required to avoid hiding of all the target objects. For example, there may be a case where, when one of a plurality of first target objects has been recognized, and a travel course can be appropriately judged thereby, there is no problem even if the other target objects are hidden. In such a case, “the probability of being able to take a correct travel course based on information that is currently held” may be calculated. Furthermore, the process for avoiding hiding may be adapted not to be performed when the probability is sufficiently high.

Further, a process described as being performed by one apparatus may be shared and executed by a plurality of apparatuses. Or alternatively, processes described as being performed by different apparatuses may be executed by one apparatus. In a computer system, what hardware configuration (server configuration) each function is realized by can be flexibly changed.

The present disclosure can be realized by supplying a computer program implemented with the functions described in the above embodiments to a computer, and one or more processors included in the computer reading out and executing the program. Such a computer program may be provided for the computer by a non-transitory computer-readable storage medium connectable to a system bus of the computer or may be provided for the computer via a network. As the non-transitory computer-readable storage medium, for example, any type of disk/disc such as a magnetic disk (a floppy (registered trademark) disk, a hard disk drive ((HDD), or the like) and an optical disc (a CD-ROM, a DVD disc, a Blu-ray disc, or the like), a read-only memory (ROM), a random-access memory (RAM), an EPROM, an EEPROM, a magnetic card, a flash memory, an optical card, and any type of medium that is appropriate for storing electronic commands are included.

What is claimed is:

1. An information processing apparatus comprising:
a controller configured to execute:
recognizing a predetermined target object based on an image acquired by a camera of a first mobile body;
estimating in advance a first probability that is a probability of not being able to normally recognize a first target object, which is a target of the recognition, by the first target object being hidden by a second mobile body; and
modifying a travel plan for the first mobile body based on the first probability.

2. The information processing apparatus according to claim 1, wherein
the controller estimates a relative positional relationship between the first mobile body and the second mobile body at timing when the first mobile body passes near the first target object, and estimates the first probability based on a result of the estimation.

3. The information processing apparatus according to claim 2, wherein
when the estimated first probability is equal to or above a predetermined value, the controller modifies the travel plan for the first mobile body so that the estimated relative positional relationship is changed.

4. The information processing apparatus according to claim 1, wherein
when the estimated first probability is equal to or above a predetermined value, the controller modifies the travel plan for the first mobile body so that a distance between the first mobile body and the second mobile body exceeds a predetermined value at timing when the first mobile body passes near the first target object.

5. The information processing apparatus according to claim 1, wherein
the first mobile body is an autonomous vehicle that travels along a predetermined route, and
the controller acquires in advance information about the first target object that needs to be recognized on the predetermined route, the first target object including one or more first target objects.

6. The information processing apparatus according to claim 5, wherein
the first target object is an object for announcing a location of a road fork.

7. The information processing apparatus according to claim 1, wherein
the controller acquires travel data about travel of the second mobile body traveling near the first mobile body, the second mobile body including one or more second mobile bodies.

8. The information processing apparatus according to claim 7, wherein
the controller acquires the travel data included in V2X messages transmitted from the second mobile body.

9. The information processing apparatus according to claim 7, wherein
the controller generates the travel data based on a result of sensing the second mobile body.

10. An information processing method to be executed by a computer, the information processing method comprising:
a first step of recognizing a predetermined target object based on an image acquired by a camera of a first mobile body;
a second step of estimating in advance a first probability that is a probability of not being able to normally recognize a first target object, which is a target of the recognition, by the first target object being hidden by a second mobile body; and
a third step of modifying a travel plan for the first mobile body based on the first probability.

11. The information processing method according to claim 10, wherein
in the second step, a relative positional relationship between the first mobile body and the second mobile body at timing when the first mobile body passes near the first target object is estimated, and the first probability is estimated based on a result of the estimation.

12. The information processing method according to claim 11, wherein
in the third step, when the estimated first probability is equal to or above a predetermined value, the travel plan for the first mobile body is modified so that the estimated relative positional relationship is changed.

13. The information processing method according to claim 10, wherein
in the third step, when the estimated first probability is equal to or above a predetermined value, the travel plan for the first mobile body is modified so that a distance between the first mobile body and the second mobile body exceeds a predetermined value at timing when the first mobile body passes near the first target object.

14. The information processing method according to claim 10, wherein
the first mobile body is an autonomous vehicle that travels along a predetermined route, and
information about the first target object that needs to be recognized on the predetermined route is acquired in advance, the first target object including one or more first target objects.

15. The information processing method according to claim 14, wherein
the first target object is an object for announcing a location of a road fork.

16. The information processing method according to claim 10, wherein
travel data about travel of the second mobile body traveling near the first mobile body is acquired, the second mobile body including one or more second mobile bodies.

17. The information processing method according to claim 16, wherein
the travel data included in V2X messages transmitted from the second mobile body is acquired.

18. The information processing method according to claim 16, wherein
the travel data is generated based on a result of sensing the second mobile body.

19. A non-transitory computer readable storing medium recording a computer program for causing a computer to perform the information processing method according to claim 10.
